(19) United States
(12) Patent Application Publication
(10) Pub. No.: US 2006/0028005 A1
(43) Pub. Date: Feb. 9, 2006

(54) Proximity suppression system tester

(76) Inventors: Mark L. Dell' Eva, Grand Blanc, MI (US); Joseph J. Spryshak, Hartland, MI (US); Kevin S. Jump, Bloomfield Hills, MI (US); Janet Hawkins, New Baltimore, MI (US); David Shock, Saint Clair Shores, MI (US); Samer R. White, West Bloomfield, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/910,416

(22) Filed: Aug. 3, 2004

(51) Int. Cl. B60R 21/16

(52) U.S. Cl. 280/735

(57) ABSTRACT

The present invention relates generally to a tester and related methods for testing vehicular safety restraint systems, and more particularly, to testers and related methods for testing airbag suppression systems. A tester or method for testing an airbag suppression system according to the invention simulates movement of a vehicle occupant into a suppression zone by causing an occupant model to move toward the suppression zone, wherein a generally rotational motion and a generally linear motion of the occupant model are independently controllable by a positioning assembly. A control assembly according to the invention is able to identify the actual position of the occupant model at the time the suppression system detects the occupant model entering the suppression zone. This position may be used to evaluate the performance of the suppression system.

### RELATED APPLICATIONS

The following applications are hereby incorporated by reference in their entirety: “PROXIMITY SUPPRESSION SYSTEM TESTER,” Ser. No. 09/844,515, filed on Apr. 27, 2001, and issued as U.S. Pat. No. 6,672,177 on Jan. 6, 2003; “SYSTEM AND METHOD FOR CONFIGURING AN IMAGING TOOL,” Ser. No. 10/457,625, filed on Jun. 9, 2003; “METHOD AND SYSTEM FOR CALIBRATING A SENSOR,” Ser. No. 10/662,653, filed on Sep. 15, 2003; and “SYSTEM AND METHOD FOR ESTIMATING DISPLACEMENT OF A SEAT-BELTED OCCUPANT,” Ser. No. 10/666,171, filed on Sep. 19, 2003.

### FIELD OF INVENTION

The present invention relates generally to a tester and related methods for testing vehicular safety restraint systems, and more particularly to testers and related methods for testing airbag suppression systems.

### BACKGROUND OF THE INVENTION

Airbags are commonly provided as safety features in modern automotive vehicles. While airbags often provide an increased level of safety for vehicle occupants, they have sometimes been alleged to be potentially detrimental to children or to other vehicle occupants who sit relatively close to the airbag door when installed in the vehicle steering wheel or dashboard. One alleged potential cause of injuries is that most current airbags deploy with a certain predetermined amount of force. While the predetermined amount of force may be appropriate for most vehicle occupants, it may arguably be too great for children or other relatively small vehicle passengers who sit close to the steering wheel or vehicle dashboard. Airbags have also been alleged to be potentially detrimental when the airbag is deployed but the vehicle passenger is not wearing a seatbelt. In such cases, the force of the vehicle deceleration is alleged to cause the unbelted passenger to be moved too close to the airbag. To address these perceived problems, efforts have been made in the airbag industry to develop suppression systems, which, based on various considerations, either suppress the airbag deployment entirely or adjust downwardly the force with which it is deployed in an impact event in which the airbag would otherwise be deployed with full force. Relatively advanced types of suppression systems include Dynamic Proximity Suppression (“DPS”) systems, which sense a vehicle occupant's movement toward the airbag during pre-impact deceleration of the vehicle and cause the airbag deployment to be adjusted based on such movement.

DPS systems include sensors to detect movement of a passenger into a “suppression zone.” The “suppression zone” is a defined space adjacent to the vehicle steering wheel or dashboard into which the airbag deploys. The particular size and shape of the suppression zone depends on the specific airbag being used, the size and configuration of the vehicle's interior space, and the age and size of the vehicle passenger. FIG. 1 is a fragmentary view of the interior of a passenger vehicle and a sample suppression zone 103 for a given airbag. Based at least in part on the output of the DPS sensors, an electronic airbag controller may suppress or adjust the deployment of the airbag upon impact.

DPS sensors require extensive testing before being approved for production. In particular, it is desirable to be able to measure the accuracy of the DPS sensors in determining when a vehicle occupant enters the suppression zone. It is also desirable to test the accuracy of a DPS sensor in determining the position and motion of the vehicle occupant relative to the vehicle at the time the DPS sensor detects suppression zone intrusion.

To test DPS sensors, typical testing devices simulate movement of a vehicle occupant into the suppression zone. These typical testing devices tend to cause only generally linear movement of a humanoid dummy into the suppression zone. However, in many situations, the movement of a vehicle occupant during pre-impact deceleration is not limited to linear movements. Often, a vehicle occupant may experience rotational movements, such as the pitching forward of the upper torso or head of the vehicle occupant.

Conventional testing devices are not designed to rigorously control simulation of a vehicle occupant's rotational motion. For example, many linear-based testing device can simulate only fixed pitch angles of vehicle occupants. Another existing testing device can simulate a rotational pitch movement only as a byproduct of a linear motion. Thus, there has been a need for a flexible tester and related methods for rigorously testing DPS sensors by controlling a wide variety and combination of body movements for various vehicle occupants.

### SUMMARY OF THE INVENTION

The present invention relates generally to a tester and related methods for testing vehicular safety restraint systems, and more particularly, to testers and related methods for testing airbag suppression systems. A tester or method for testing an airbag suppression system according to the invention simulates movement of a vehicle occupant into a suppression zone by causing an occupant model to move toward the suppression zone, wherein a generally rotational motion and a generally linear motion of the occupant model are independently controllable by a positioning assembly. A control assembly according to the invention is able to identify the actual position of the occupant model at the time the suppression system detects the occupant model entering the suppression zone. This position may be used to evaluate the performance of the suppression system.

### BRIEF DESCRIPTION OF THE DRAWINGS

FIG. 1 is a fragmentary view of the interior of a passenger vehicle, showing a human passenger and a sample airbag suppression zone.

FIG. 2 is a schematic diagram illustrating an embodiment of a tester according to the invention for testing an airbag suppression sensor.

FIG. 3 is an elevational view of a positioning assembly according to the invention and an occupant model in a vehicle environment.

FIG. 4 is a similar view of the positioning assembly of FIG. 3 with actuator members of the positioning assembly extended.

FIG. 5 is another similar view of the positioning assembly of FIG. 3, showing a first one of the actuator members positioned at two different angles.

FIG. 6 is a similar view of the positioning assembly of FIG. 5, showing the first actuator member positioned at a third angle.

FIG. 7 is a perspective view of the positioning assembly of FIG. 3.

FIG. 8 is a diagrammatic view showing a particular occupant model at two different positions in relation to a suppression zone in a vehicle environment.

FIG. 9 shows another occupant model at two different positions in relation to a suppression zone.

FIG. 10 shows the occupant model of FIG. 9 at two different positions representative of a childlike model being directly propelled out of a child restraint.

### DETAILED DESCRIPTION OF A PREFERRED EMBODIMENT

The present invention relates generally to testing vehicular safety restraint systems, and more particularly to a testing apparatus (“tester”) and related methods for testing airbag suppression systems. Specifically, the testers and related methods provide for testing suppression system sensors, including by simulating movement of a vehicle occupant toward a suppression zone. The methods and testers disclosed herein are capable of simulating a wide variety of motions for various categories of vehicle occupants, including simulating general rotational motions and general linear motions independently of one another. Throughout the specification and the claims, rotational motion is meant to be understood as a rotational pitching of a vehicle occupant, preferably in a generally forward or aft direction. Rotational motion can include but is not limited to an upper portion of the vehicle occupant pitching generally forward or backward relative to a lower portion of the vehicle occupant.

In the discussion below and in the claims, the term “acceleration” is defined broadly to include both positive and negative acceleration (deceleration), as well as constant acceleration. Similarly, the term “velocity” is defined broadly to include velocities in different directions, as well as constant velocities.

### I. Schematic View of an Exemplary Tester

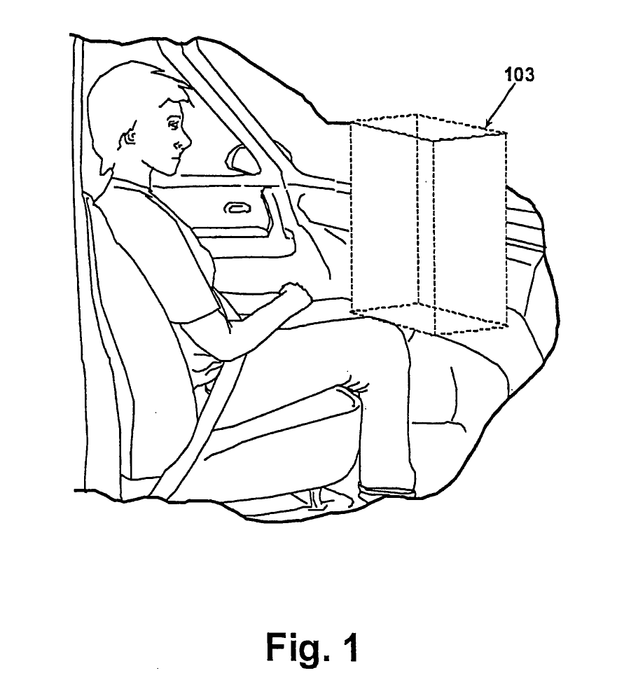

FIG. 1 illustrates a vehicular environment in which a vehicular restraint system may be implemented. As shown, the environment may include a human passenger and a sample airbag suppression zone 103. In general, the vehicular restraint system includes sensor(s) (not shown) for detecting an intrusion into the suppression zone 103. For example, an intrusion sensor may be configured to detect when the vehicle passenger enters the area defined by the suppression zone 103. Upon detection of an intrusion into the suppression zone 103, the vehicular restraint system can initiate appropriate actions, such as deploying a restraint device.

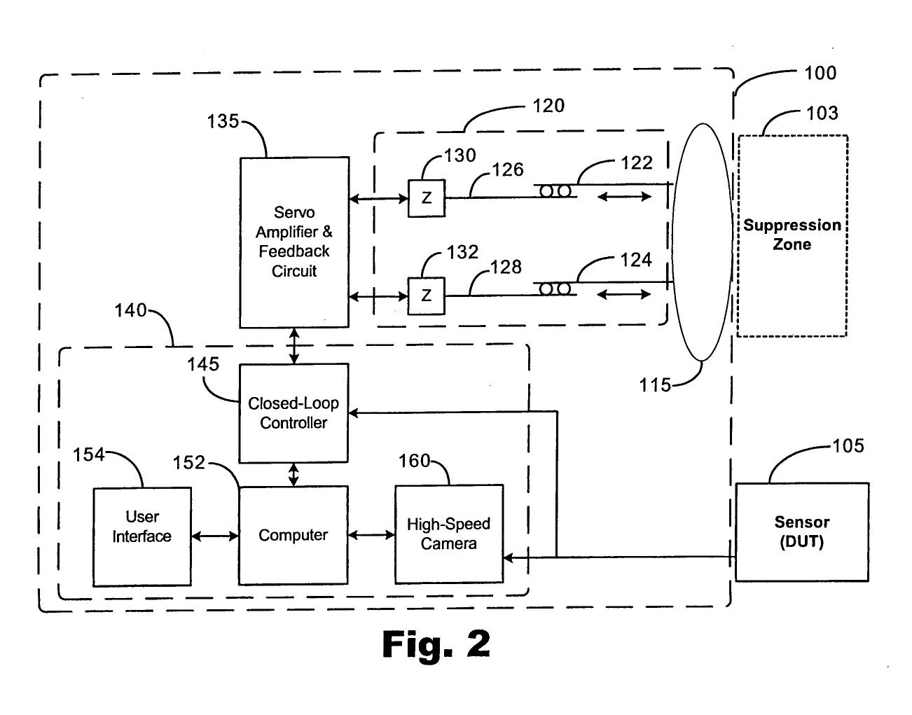

Referring now to FIG. 2, an exemplary embodiment of a tester 100 for testing an intrusion sensor 105 (“sensor 105” or “device under test (DUT) 105”) of an airbag suppression system is set forth. The sensor 105 can comprise any number or arrangement of sensors 105 that are configured to detect an intrusion into the suppression zone 103. To facilitate testing of the sensor 105, the tester 100 can cause an occupant model 115 to enter the suppression zone 103. The sensor 105 then detects the intrusion of the occupant model 115 into the suppression zone 103. The tester 100 can evaluate the performance of the sensor 105 by analyzing the position of the occupant model 115 relative to the suppression zone 103 at the time the sensor 105 detects the intrusion into the suppression zone 103.

A. Occupant Model

The tester 100 utilizes the occupant model 115 to simulate movement of a vehicle occupant, such as the vehicle passenger shown in FIG. 1. Accordingly, the occupant model 115 can include any object capable of simulating movement of possible vehicle occupants. For example, the occupant model 115 may comprise, but is not limited to, any size of anthropomorphic dummy suitable for simulating a vehicle occupant, as well as any combination of an anthropomorphic dummy and a restraint device such as a child restraint device (“child restraint”). When the restraint device is a child restraint, the child restraint may include but is not limited to a booster seat, a convertible child seat, a forward facing child seat, a rearward facing child seat, an infant car bed, and an infant seat. Further, the occupant model 115 can include any geometrical object that can be sensed by the sensor 105. Simulations using some of the different occupant models 115 will be discussed below.

B. Positioning Assembly

The tester 100 can include a positioning assembly 120 for controlling the motion of the occupant model 115. As shown in FIG. 2, the positioning assembly 120 may include a first actuator member 122 and a second actuator member 124 configured to translate, including extending to cause the occupant model 115 to move toward and/or into the suppression zone 103. Preferably, the first and second actuator members 122, 124 are configured to translate along generally forward-aft oriented axes. While a number of different device configurations can be used to extend the actuator members 122, 124, FIG. 2 represents an exemplary embodiment in which the actuator members 122, 124 are caused to move by belt-driven slides along guide rails 126, 128.

The guide rails 126, 128 are preferably oriented along generally forward-aft axes (“Z direction”), although dissimilar movements of the actuator members 122, 124 do not limit movement of the occupant model 115 strictly to the Z direction. Dissimilar movements of the actuator members 122, 124 generally cause the occupant model 115 to undergo generally linear and/or generally rotational motions, which may include motions in the Z direction, as well as motions in other directions (e.g., X direction, Y direction, or some combination of X, Y, and Z directions). For example, dissimilar translations of the actuator members 122, 124 can cause an upper portion of the occupant model 115 to rotate generally forward in an arcing motion that includes movements in both the Z direction and the Y direction.

To facilitate the generally rotational and linear motions, the actuator members 122, 124 can be connected to the occupant model 115 at pivot points. For example, in a preferred embodiment, the actuator members 122, 124 are configured to couple to the occupant model 115 by pins (not shown) that allow for pivoting movements when secured to receiving holes (not shown) in the occupant model 115. The occupant model 115 may include multiple hole locations along a channel, which allows the actuator members 122, 124 to be connected at various positions of the occupant model 115. Alternatively, the actuator members 122, 124 can simply abut the occupant model 115 without being fixedly connected. Some of the various ways that the tester 100 can move the occupant model 115 in generally linear and/or rotational motions will be discussed in greater detail below.

Servo motors 130, 132 may be used to drive the actuator members 122, 124. The servo motors 130, 132 shown in FIG. 2 are designed to move the actuator members 122, 124 along the guide rails 126, 128. The servo motors 130, 132 should be capable exerting sufficient force upon the actuator members 122, 124 to cause accelerations and/or velocities that accurately simulate high-speed movements associated with rapid vehicle decelerations. In a preferred embodiment, the servo motors 130, 132 can exert enough force to cause accelerations of approximately 0.8 g-units (“G”) (7.8 meters per square second) and above. In another preferred embodiment, the servo motors 130, 132 can exert enough force to cause accelerations of approximately 1.2 G (11.8 meters per square second). The servo motors 130, 132 can be disabled under certain predefined conditions, such as when a door of a vehicle of the testing environment is indicated to be “open.”

C. Servo Amplifier and Feedback Circuit

A servo amplifier and feedback circuit 135 (“feedback circuit 135”) can be connected to the servo motors 130, 132, which together control the positioning assembly 120. The feedback circuit 135 functions to amplify the power supplied to the servo motors 130, 132. Further, the feedback circuit 135 receives feedback information from the positioning assembly 120 relating to a current position of the actuator members 122, 124. The feedback circuit 135 can then use the feedback information to precisely control the positioning assembly 120.

D. Control and Analysis Assembly

The tester 100 may include a control and analysis assembly 140 (“control assembly 140”) configured to control the positioning assembly 120 and analyze the performance of the sensor 105 based on test simulations. In particular, the control assembly 140 can identify an actual position of the occupant model 115, such as the actual position of the occupant model 115 that corresponds to when the suppression system sensor 105 detects the occupant model 115 entering the suppression zone 103. As shown in FIG. 2, the control assembly 140 can include a closed-loop controller 145, a computer 152, a user interface 154, and a high-speed camera 160.

1. Closed-Loop Controller

The closed-loop controller 145 can communicate with the feedback circuit 135 and the suppression system sensor 105 to generate motor control signals to control the positioning assembly 120. The closed-loop controller 145 can also record data relating to the motion and position of the occupant model 115, as well as the time at which the sensor 105 detects intrusion into the suppression zone 103.

2. Computer

The closed-loop controller 145 can communicate with the computer 152. Accordingly, the computer 152 may receive recorded data from the closed-loop controller 145. The computer 152 can employ application-specific software for processing and analyzing the recorded data received from the closed-loop controller 145. Preferably, the computer 152 receives data related to the intrusion signal generated by the sensor 105. In a preferred embodiment, the closed-loop controller 145 is resident in the computer 152.

The computer 152 can employ application-specific software providing for the receipt and processing of control commands from a human operator using the user interface 154. Further, the computer 152 can provide output information to the human operator using the user interface 154. In a preferred embodiment, the computer 152 is a personal computer. In other embodiments, other known types of control devices can be used in place of or in combination with the computer 152.

The computer 152 can also communicate with the high-speed camera 160. In particular, the computer 152 may receive and process images acquired by the high-speed camera 160. This allows the computer 152 to use the acquired images to analyze the performance of the sensor 105. For example, the computer 152 can identify a particular image representative of the position of the occupant model 115 at the time the sensor 105 detected entry into the suppression zone 103. From the identified image, the computer 152 can identify the actual position and/or motion of the occupant model 115 corresponding to when the suppression system detects the occupant model 115 entering the suppression zone 103. The computer 152 can then determine a performance factor of the sensor 105 based on the identified actual position of the occupant model 115.

In alternative embodiments, the computer 152 can receive positional data for the occupant model 115 from sources other than or in addition to the camera 160. For example, the servos 130, 132 may include mechanisms for determining the positions of the actuator members 122, 124 relative to the suppression zone 103 independently of the camera 160. The computer 152 can then use the positions of the actuator members 122, 124 to determine the position of the occupant model 115. This exemplary alternative embodiment will be discussed in more detail below.

C. User Interface

The user interface 154 can comprise any number of known input or output devices. For example, the user interface 154 may include a keyboard, a mouse, a graphic display, a graphic user interface, a touch screen, and any other device capable of providing communication between the computer 152 and the human operator.

D. High-Speed Camera

The high speed camera 160 should be configured to capture images representative of the position and/or motion of the occupant model 115 in relation to the suppression zone 103. Preferably, the camera 160 acquires a stream of images as the occupant model 115 is moved toward and into the suppression zone 103. The camera 160 may receive an intrusion signal from the sensor 105 to help capture or identify a particular image that corresponds with the intrusion signal.

The high speed camera 160 should be capable of rapidly capturing detailed images such that data is accurate even when the occupant model 115 is moving at a rapid speed. Accordingly, the camera 160 should provide adequate frame rates, resolution, and storage. In a preferred embodiment, the camera 160 is capable of capturing images at a rate of at least approximately 500 frames per second.

Further, the camera 160 should include a lens configured to capture the occupant model 115 as it enters the suppression zone 103. This allows the tester 100 to use the captured images to analyze the sensor's 105 performance in detecting an intrusion into the suppression zone 103. The lens should provide adequate resolution and low distortion for the correct field-of-view, even at a short camera-to-object view that is typical within a vehicle.

Preferably, the camera 160 is also capable of capturing images of the occupant model 115 as it moves toward the suppression zone 103. The tester 100 can then use the captured images to analyze a wide variety of motions that the occupant model 115 may undergo as it moves toward and into the suppression zone 103. In other words, the tester 100 can use the collection of imagery for the development, validation, and certification of safety restraint systems.

By employing the high-speed camera 160, the tester 100 can robustly test the sensor 105 in a wide variety of contexts. For example, the high-speed camera 160 enables the tester 100 to analyze the performance of the sensor 105 when the occupant model 115 is ejected from a restraint device. Assuming that the occupant model 115 includes a childlike model seated in a child restraint device, the tester 100 can propel the childlike model out of the seat to simulate a case where a child is not secured to the restraint device. By using the high-speed camera 160 to capture images of the occupant model 115, the position of the ejected child can be determined even when the child is not attached to the actuator members 122, 124.

### II. Positioning Assembly Views

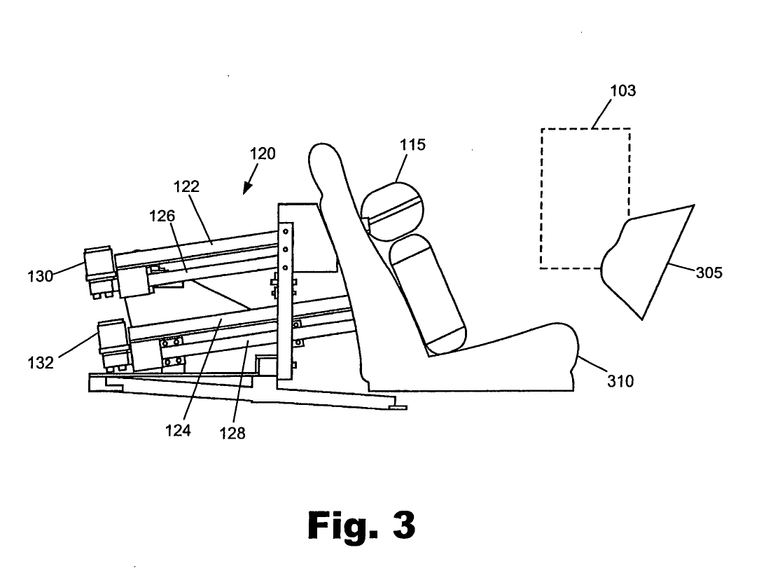

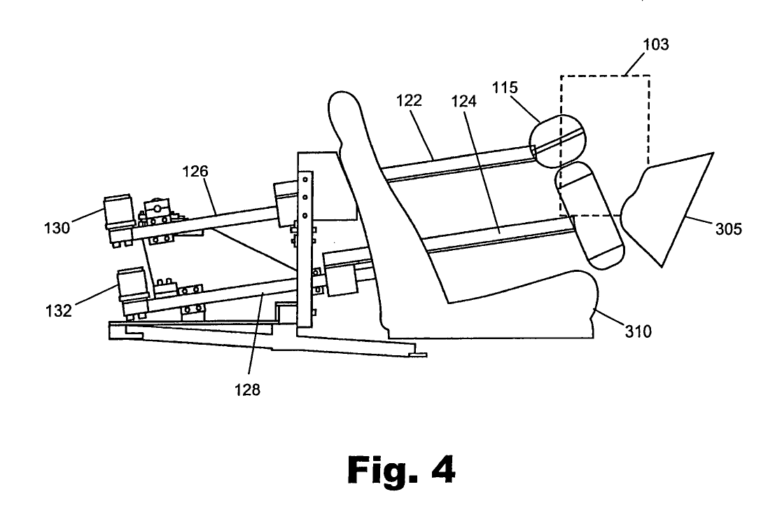

FIGS. 3 and 4 are side-views of the positioning assembly 120 and occupant model 115 in a vehicle environment. As shown in FIG. 3, the vehicle environment can include the suppression zone 103 near a dashboard 305, as well as a seat 310 supportive of the occupant model 115. The positioning assembly 120 may include the actuator members 122, 124 configured to move the occupant model 115 relative to the vehicle environment. In particular, the actuator members 122, 124 can be configured to apply forces upon the occupant model 115 through the back of the seat 310. For simulation of some occupant movements, the actuator members 122, 124 may be coupled to the occupant model 115. Other movements are simulated without fixedly attaching the actuator members 122, 124 to the occupant model 115. For example, the occupant model 115 can be propelled forward into free flight when the actuator members 122, 124 are not fixedly attached to the occupant model 115.

The actuator members 122, 124 can translate, either singly or in combination, to cause the occupant member 115 to move in a wide variety of motions. By translating, the actuator members 122, 124 cause the occupant model 115 to undergo generally linear motions, including controlled accelerations and/or velocities. A generally linear motion should be understood to mean a translation of the occupant model 115 generally along the forward-aft axis defined by the second actuator arm 124. This includes generally linear translation of the occupant model 115 towards the suppression zone 103. FIG. 4 shows the actuator members 122, 124 extended to cause the occupant model 115 to move into the suppression zone 103 by means of a generally linear motion.

The actuator members 122, 124 are independently controllable. In other words, the actuator members 122, 124 can be controlled to move independently of one another. This provides flexibility for simulating various motions of the occupant model 115. For example, the first actuator member 122 can move independently of the second actuator member 124 to cause the occupant model 115 to rotate at controlled rotational accelerations and/or velocities. In particular, the first actuator member 122 can translate at displacements dissimilar to the displacements of the second actuator member 124 to cause an upper portion of the occupant model 115 to pitch forward or backward in relation to a lower portion the occupant model 115.

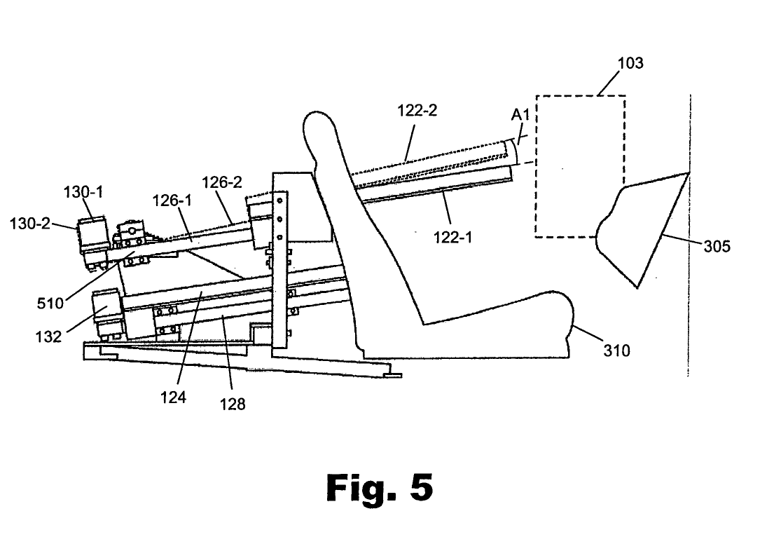

The independent controllability of the actuator members 122, 124 allows the positioning assembly 120 to simulate generally rotational motions of the occupant model 115 independently of generally linear motions of the occupant model 115. To accommodate rotational motions of the occupant model 115, the first actuator member 122 should be configured to change its degree of incline by pivoting about a pivot point or axis. This allows the first actuator member 122 to move along an arc, thereby causing an upper portion of the occupant model 115 to undergo rotational motion along the same arc. For example, FIG. 5 is another side-view of the positioning assembly 120 of FIG. 3, showing the first actuator member 122 positioned at different inclines. As shown, the first actuator member 122 can be positioned at a first position denoted by a first actuator member 122-1 coupled to a guide rail 126-1 and a servo motor 130-1. The first actuator member 122 can incline to be positioned at a second angular position indicated by a first actuator member 122-2 coupled to an inclined guide rail 126-2 and servo motor 130-2. The angle of incline between the first position 122-1 and the second position 122-2 of the first actuator member 122 is denoted in FIG. 5 as A1.

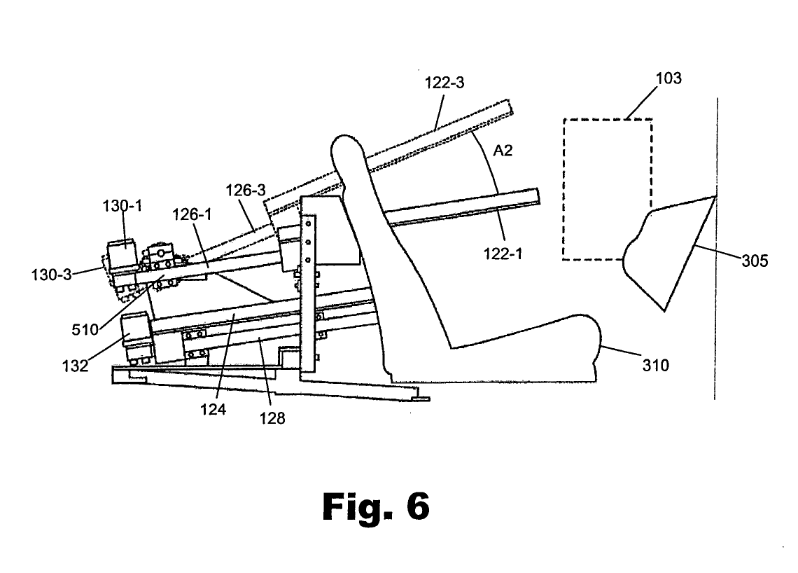

FIG. 6 shows the first actuator member 122 inclined at a third angular position denoted by an inclined first actuator member 122-3 coupled to an inclined guide rail 122-3 and servo motor 122-3. The angle of incline between the first position 122-1 and the third position 122-3 of the first actuator member 122 is denoted in FIG. 6 as A2. While FIGS. 5 and 6 show specific positions of incline, the actuator member 122 can incline at various angles generally over a range that is helpful for causing the occupant model 115 to undergo rotational motion. For example, as the actuator members 122, 124 move at dissimilar displacements, an upper portion of the occupant model 115 translates along an arc. The first actuator member 122 may change its angle of incline as it translates to allow for this movement along the arc. As the first actuator member 122 extends, its angle of incline may increase until a highest point of an arc is reached and decrease thereafter, allowing a portion of the occupant model 115 to follow the general shape of the arc.

In addition to allowing the occupant model 115 to undergo controlled rotational motions, the variable angle of incline of the first actuator member 122 also allows the tester 100 to simulate movements for occupant models 115 of various sizes. The first actuator member 122 can be inclined to connect to an occupant model 115 that is made to represent an adult vehicle passenger. Alternatively, the first actuator member 122 can be lowered to connect to a shorter occupant model 115, such as an occupant model 115 representative of a child vehicle passenger.

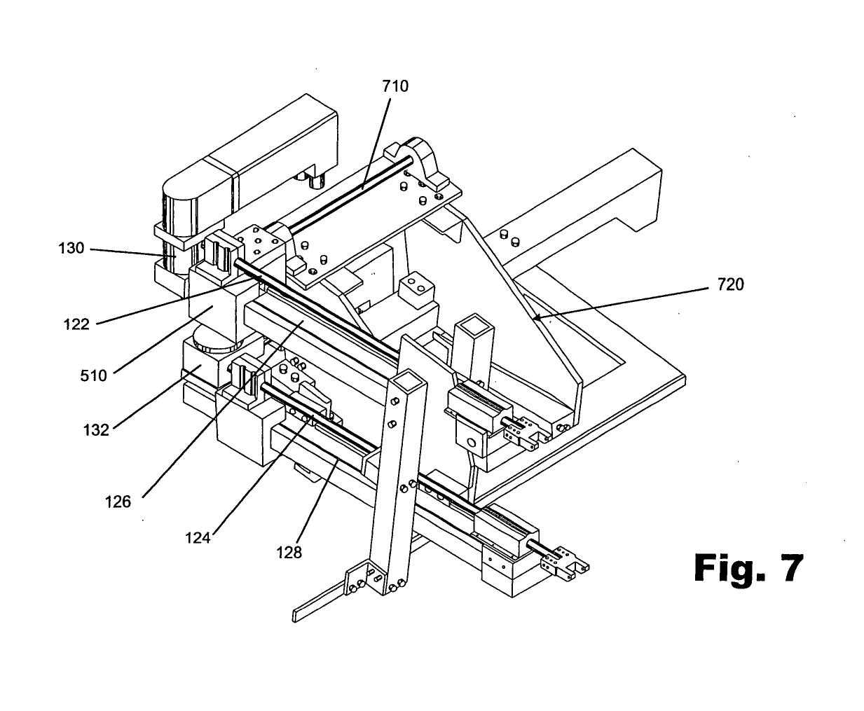

As shown in FIGS. 5 and 6, the first actuator member 122 may change its angle of incline by pivoting about a pivot point 510. FIG. 7 is a perspective view of the positioning assembly 120 of FIG. 3. FIG. 7 shows that the positioning assembly 120 may include a pivot axle 710 as part of a frame 720. The pivot axle 710 is configured to aid the pivoting of the first actuator member 122 about the pivot point 510. The frame 720 can comprise any shape, size, and material capable of supporting the positioning assembly 120 in a vehicle simulation environment. In a preferred embodiment, the frame 720 is configured for positioning generally behind the seat 310 of a vehicle environment or a simulated vehicle environment.

By being independently controllable, the actuator members 122, 124 are capable of robustly and controllably simulating generally rotational and linear motions that reflect real motions experienced by vehicle occupants during driving and especially during pre-impact or near-impact conditions. For example, when vehicle brakes are applied prior to impact, a vehicle occupant's upper body is likely to rotate generally forward relative to the lower body portion, which is fixed on the seat 310 and more likely to slide generally forward if not restrained by a safety device. To simulate such motions, the dissimilar displacement of the actuator members 122, 124 in relation to one another tends to cause the occupant model 115 to undergo generally linear and generally rotational motions, such as rotational acceleration and/or velocity.

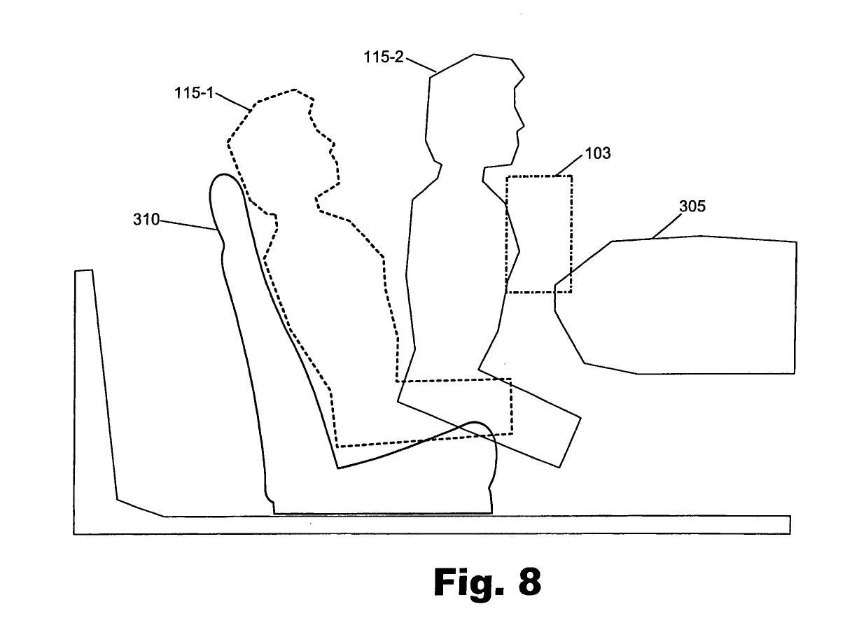

FIG. 8 illustrates a particular occupant model 115 moving toward a suppression zone 103 in a manner controlled by the positioning assembly 120. The occupant model 115 is shown at a first position 115-1 (indicated by dashed lines) and at a second position 115-2 in a vehicle environment. At the first position 115-1, the occupant model 115 rests against the back of the seat 310. Upon being subjected to both a generally rotational and a generally linear motion, the occupant model 115 moves to the second position 115-2. This second position 115-2 represents a snap-shot of the occupant model 115 as it moves into the suppression zone 103. Note that the occupant model 115 has been controllably forced to both translate and rotate to arrive at the second position 115-2.

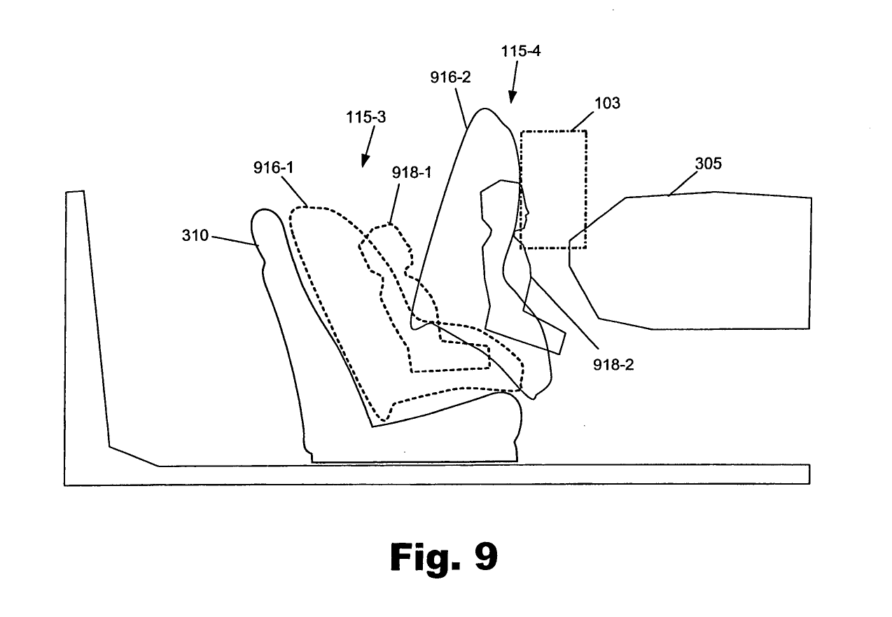

FIG. 9 shows another particular occupant model 115 at a first position 115-3 (indicated by dashed lines) and a second position 115-4 in a vehicle environment. As shown, the occupant model 115 comprises a child restraint 916 supporting a childlike model 918. In the first position 115-3, the child restraint 916 is in a first position 916-1 and childlike model is in a first position 918-1. The tester 100 can be configured to propel the child restraint 916 from the first position 916-1 and to a second position denoted generally by 115-4. As shown in FIG. 9, the childlike model 918 at first position 918-1 can be unrestrained to simulate movement of the childlike model 918 being ejected (denoted by second position 918-2) from the child restraint 916. In FIG. 9, the child restraint 916 is shown as being transparent to help illustrate the motion of the childlike model 918. Note that the child restraint 916 has both translated and rotated to move from the first position 916-1 to the second position 916-2.

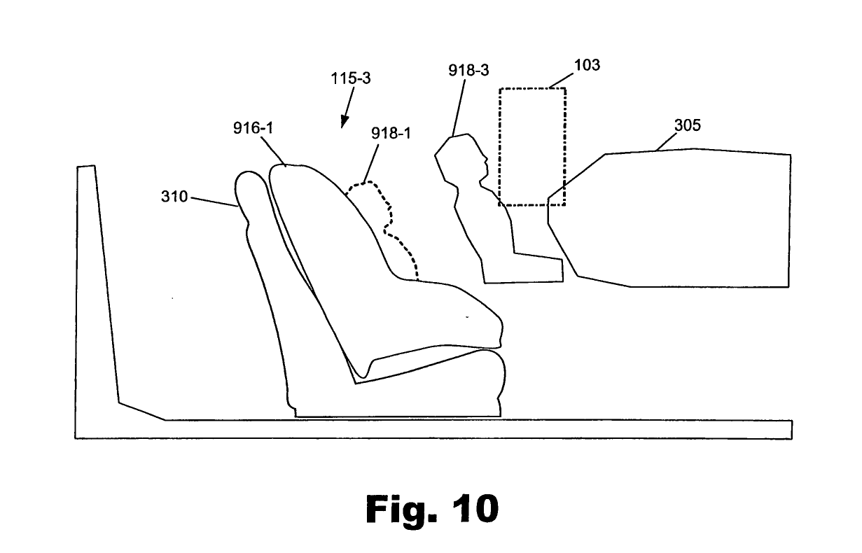

Alternatively, the child restraint 916 can be modified such that the tester 100 can directly propel the childlike model 918 out of the child restraint 916. This simulated movement is illustrated by FIG. 10, in which the childlike model 918 is shown to be ejected from a first position 918-1 in the child restraint 916 and into a second position denoted as 918-3.

FIGS. 8-10 illustrate non-inclusive examples of possible motions that the tester 100 can simulate for various types of occupant models 115. Thus, independent controllability of the generally rotational and generally linear motions provides robust capabilities for testing airbag suppression systems by allowing the tester 100 to simulate many possible motions and positions of myriad types of vehicle occupants.

### III. Exemplary Operation

In operation, the tester 100 described above can be used to test sensors 105 of airbag suppression systems as follows. Typically, a human operator provides certain setup and control information to the application-specific software running on the computer 152. In particular, the human operator may input instructions to the computer 152. The computer 152 can then control the positioning assembly 120 to cause the occupant model to move according to the provided instructions.

The tester 100 can perform a dynamic test in which the positioning assembly 120 rapidly moves the occupant model 115 into the suppression zone 103, thereby simulating a situation where a vehicle is engaged in pre-impact braking prior to a crash. In a preferred embodiment, the human operator can choose between multiple motion profiles for the occupant model 115. For example, the positioning assembly 120 can cause the occupant model to move into the suppression zone 103 at a constant velocity or a constant acceleration, such as a constant rotational velocity or acceleration. Constant acceleration motions can be used to simulate motion of an unrestrained vehicle occupant during vehicle deceleration. Other motion profiles can be used as well to simulate other conditions, including any of the situations discussed above.

Regardless of the particular motion profile applied, the computer 152 and closed-loop controller 145 issue control commands to the servo amplifier and feedback circuit 135, which in turn controls the servo motors 130, 132 and other devices that actuate the various components of the positioning assembly 120. The positioning assembly 120 then causes the occupant model 115 to move toward the suppression zone 103 according to the selected motion profiles. In a preferred embodiment, the controlled movement of the occupant model 115 is simulated by controlling the generally rotational motion of the occupant model 115 independent of the generally linear motion of the occupant model 115.

As the occupant model 115 moves toward the suppression zone 103, the camera 160 captures images. The sensor 105 indicates when the occupant model 115 enters the suppression zone 103. The acquired images and the intrusion signal are provided to the computer 152 for analysis. The computer 152 can then identify the actual position of the occupant model 115 at the time that the suppression system sensor 105 detected intrusion of the occupant model 115 into the suppression zone 103. The tester 100 can use the identified position to determine a performance factor for the sensor 105.

### IV. Alternative Embodiments

As mentioned above, in alternative embodiments, known devices for determining the position of the occupant model 115 can be used in place of or in addition to the high speed camera 160. In one embodiment, the servos 130, 132 include mechanisms for determining the position of the actuator members 122, 124 relative to the suppression zone 103. These mechanisms can be calibrated during setup of the tester 100 by moving the occupant model 115 into the suppression zone 103 at a slow rate. The position of the occupant model 115 is then determined at the time it enters the suppression zone 103. This determined position can then be used during operation of the tester 100 as a calibration position for the occupant model 115 in relation to the suppression zone 103. In one embodiment, the actuator members 122, 124 include linear encoders that are used as backup measurement mechanisms.

The tester 100 is not limited to implementing two actuator members. In other alternative embodiments, the tester 100 can implement more than two actuator members configured to cause the occupant model 115 to undergo generally rotational and translational motion. For example, in one embodiment, the tester 100 can include four independently controllable actuator members that can displace the occupant model 115 independently of one another. In this configuration, the occupant model 115 can be made to rotate about longitudinal and/or lateral axes, which provides the tester 100 with increased flexibility to simulate various motions of vehicle passengers.

Further, the actuator members 122, 124 can be relationally positioned in configurations different than that shown in the Figures. For example, alternative embodiments of the tester 100 can include actuator members 122, 124 that are positioned in a generally horizontal configuration. This allows the tester 100 to simulate rotational motion of the occupant model 115 about a generally vertical axis. Similarly, it is anticipated that the actuator members 122, 124 can be positioned at different relational configurations to simulate rotation in various planes of motion. Thus, different configurations of multiple actuator members 122, 124 allow myriad motions to be simulated for testing restraint systems.

In a particular alternative embodiment, both the first and second actuator members 122, 124 can be configured to change their respective angles of incline by pivoting about their respective pivot points. This feature allows the tester 100 to simulate even a wider range of motions than those described above, including a lower portion of the occupant model 115 pitching forward in relation to an upper portion of the occupant model 115, which motion may be helpful to simulate a vehicle occupant that is restrained only by a shoulder restraint. This feature also allows the tester 100 additional flexibility for implementation in various vehicle environments that may have seats 310 of different designs and/or angular orientations.

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope. Therefore, the following claims define the scope and content of the invention.

What is claimed is:

1. A tester for testing an airbag suppression system that monitors movement of a vehicle occupant into a suppression zone, comprising:
an occupant model;
a positioning assembly configured to cause controlled movement of said occupant model toward the suppression zone, wherein a generally rotational motion and a generally linear motion of said occupant model are independently controllable by said positioning assembly; and
a control assembly configured to identify an actual position of said occupant model corresponding to when the suppression system detects said occupant model entering the suppression zone.

2. The tester of claim 1, wherein said positioning assembly comprises:
a plurality of actuator members, including a first actuator member and a second actuator configured to cause said controlled movement.

3. The tester of claim 2, wherein said first actuator member and said second actuator member are configured to cause said generally rotational motion by translating at different displacements.

4. The tester of claim 3, wherein said different displacements cause an upper portion of said occupant model to rotationally pitch in relation to a lower portion of said occupant model.

5. The tester of claim 2, wherein said first actuator member is configured to change its angle of incline to move along an arc as it translates.

6. The tester of claim 1, wherein said generally rotational motion includes at least one of a rotational acceleration and a rotational velocity, while said generally linear motion includes at least one of a linear acceleration and a linear velocity.

7. The tester of claim 1, wherein said positioning assembly is configured to simultaneously control said generally rotational motion and said generally linear motion of said occupant model.

8. The tester of claim 1, wherein said occupant model comprises a child restraint supporting a childlike model.

9. The tester of claim 8, wherein said positioning assembly is configured to propel said childlike model from said child restraint.

10. The tester of claim 1, further comprising a camera configured to acquire an image of said occupant model, said image being representative of said actual position of said occupant model.

11. The tester of claim 1, further comprising a camera configured to acquire a plurality of images from which said control assembly is configured to identify said actual position of said occupant model.

12. The tester of claim 1, wherein said control assembly is configured to determine a performance factor of the airbag suppression system based on said actual position of said occupant model.

13. An apparatus for simulating movement of a vehicle occupant into a suppression zone of an airbag suppression system, comprising:
an occupant model; and
a positioning assembly configured to cause controlled movement of said occupant model toward the suppression zone, wherein a generally rotational motion and a generally linear motion of said occupant model are independently controllable by said positioning assembly.

14. The apparatus of claim 13, wherein said positioning assembly comprises:
a plurality of actuator members, including a first actuator member and a second actuator configured to cause said controlled movement.

15. The apparatus of claim 14, wherein said first actuator member and said second actuator member are configured to cause said generally rotational motion by translating at different displacements.

16. The apparatus of claim 15, wherein said different displacements cause an upper portion of said occupant model to rotationally pitch in relation to a lower portion of said occupant model.

17. The apparatus of claim 14, wherein said first actuator member is configured to change its angle of incline to move along an arc as it translates.

18. The apparatus of claim 13, wherein said generally rotational motion includes at least one of a rotational acceleration and a rotational velocity, while said generally linear motion includes at least one of a linear acceleration and a linear velocity.

19. The apparatus of claim 13, wherein said positioning assembly is configured to simultaneously control said generally rotational motion and said generally linear motion of said occupant model.

20. The apparatus of claim 13, wherein said occupant model comprises a child restraint supporting a childlike model.

21. The apparatus of claim 20, wherein said positioning assembly is configured to propel said childlike model from said child restraint.

22. A method for testing an airbag suppression system that monitors movement of a vehicle occupant into a suppression zone, comprising:
providing an occupant model;
causing movement of said occupant model toward the suppression zone, including controlling a generally rotational motion and a generally linear motion independently of one another; and
identifying an actual position of said occupant model corresponding to when the suppression system detects said occupant model entering the suppression zone.

23. The method of claim 22, wherein said step of causing movement includes translating a first actuator member and a second actuator member at different displacements.

24. The method of claim 22, wherein said step of controlling includes moving a first actuator member along an arc as it translates.

25. The method of claim 22, wherein said step of controlling includes rotationally pitching an upper portion of said occupant model in relation to a lower portion of said occupant model by translating a first actuator member and a second actuator member at different displacements.

26. The method of claim 22, wherein said step of controlling includes rotationally accelerating said occupant model independent of said generally linear motion.

27. The method of claim 22, wherein said step of controlling includes simultaneously controlling said generally rotational motion and said generally linear motion of said occupant model.

28. The method of claim 22, wherein said occupant model comprises a child restraint and a childlike model, and wherein said step of causing movement includes propelling said childlike model from said child restraint.

29. The method of claim 22, further comprising determining a performance factor of the airbag suppression system based on said actual position of said occupant model.

30. The method of claim 22, wherein said identifying step comprises acquiring an image of said occupant model, said image being representative of said actual position of said occupant model.

31. A method for simulating movement of a vehicle occupant toward a suppression zone of an airbag suppression system, comprising:
causing movement of an occupant model toward the suppression zone, including:
controlling a generally linear motion of an occupant model toward the suppression zone; and
controlling a generally rotational motion of said occupant model independent of said generally linear motion.

32. The method of claim 31, wherein said step of controlling said generally rotational motion includes translating a first actuator member and a second actuator member at different displacements.

33. The method of claim 32, wherein said first actuator member and said second actuator member are translated at different displacements in a generally similarly direction of motion.

34. The method of claim 31, wherein said step of controlling said generally rotational motion includes rotationally pitching an upper portion of said occupant model in relation to a lower portion of said occupant model by translating a first actuator member and a second actuator member at different displacements.

35. The method of claim 31, wherein said step of controlling said generally rotational motion includes rotationally accelerating said occupant model independent of said generally linear motion.

36. The method of claim 31, wherein said steps of controlling are performed simultaneously.
